(19) United States
(12) Patent Application Publication
(10) Pub. No.: US 2026/0211650 A1
(43) Pub. Date: Jul. 23, 2026

(54) COMPILING SQL INTRINSICS FOR PARALLEL EXECUTION

(71) Applicant: Microsoft Technology Licensing, LLC, Redmond, WA (US)

(72) Inventors: Kaushik RAJAN, Redmond, WA (US); Sampath RAJENDRA, Bangalore (IN); Avery Sumner LAIRD, Toronto (CA)

(21) Appl. No.: 19/035,798

(22) Filed: Jan. 23, 2025

(51) Int. Cl. G06F 8/41; G06F 9/38; G06F 16/2458

(52) U.S. Cl. CPC G06F 8/443; G06F 9/3887; G06F 9/3888; G06F 16/2458

(57) ABSTRACT

A structured query language (SQL) query including an SQL intrinsic function is processed using native code including single instruction multiple data (SIMD) or single instruction multiple thread (SIMT) processor instructions for execution on a processor having native parallelism. The native code is compiled from an implementation of the SQL intrinsic function in a platform-independent source code. The compiling comprises compiling the source code to generate a platform-independent intermediate representation (IR) of the source code. The IR is optimized for improved performance through parallelization. The optimized IR is lowered to generate the native code.

### BACKGROUND

Structured query language (SQL) underpins user and systems interfaces with most modern databases. SQL was developed over 50 years ago and over the ensuing decades its syntax has been enhanced with many intrinsic functions. SQL intrinsic functions are provided by SQL database to perform operations on data. For example, an intrinsic string functions exists for converting text to upper case format, an intrinsic numeric function exists for rounding numbers, and an intrinsic date and time function exists for calculating the number of days between two given dates. Each intrinsic function is implemented by writing source code in a high-level language such as C++ and then compiling that source code into an executable form for execution by a processor. Over the decades, hundreds and hundreds of intrinsic functions have been added to major SQL implementations and the implementations of these intrinsic functions have been continually improved and refined to optimize performance in most situations.

However, modern computing has changed with the introduction and rapid advancement of processors having native parallelism have been introduced. Such processors include vector-capable central processing units (CPUs) and coprocessors, including graphical processing units (GPUs), capable of tens, hundreds, or even thousands of simultaneous calculations using single instruction multiple data (SIMD) instructions. A state-of-the-art GPU has over 16,000 processing cores. Modern CPUs provide native parallelism via instruction set extensions such as Advanced Vector Extensions (AVX)2, AVX-512, Extended Operations (XOP), NEON™, Scalable Vector Extensions (SVE), and SVE2, which are available on various mass-market central processing units (CPUs). Unfortunately, many existing SQL intrinsic function implementations were written without taking advantage of data parallelism of modern processors.

### SUMMARY

Example solutions for executing structured query language (SQL) intrinsic function implementations and for compiling SQL intrinsic functions to run on modern processors are described herein. The disclosed examples are described in detail below with reference to the accompanying drawing figures listed below. The following summary is provided to illustrate some examples disclosed herein.

In certain examples, a method for processing SQL queries includes receiving an SQL query at an SQL query processor, the SQL query processor being capable of executing data-parallel instructions. Within the SQL query, an intrinsic SQL function is identified. The intrinsic SQL function is processed on the processor using native code generated from an implementation of the intrinsic SQL function in a platform-independent source code. The source code is compiled to generate an intermediate representation (IR) of the implementation of the intrinsic SQL function, the IR being platform independent and retargetable. The IR of the implementation of the intrinsic SQL function is then optimized to generate an optimized IR, wherein the optimizing includes modifying the IR for improved performance through parallelization. The optimized IR is lowered to the native code.

### BRIEF DESCRIPTION OF THE DRAWINGS

The disclosed examples are described in detail below with reference to the accompanying drawing figures listed below:

FIG. 1 is a block diagram illustrating by way of example an execution environment for a database engine.

FIG. 2 shows a sampling of intrinsic operators that can be used within an SQL query to process data.

FIGS. 3A, 3B, 3C, and 3D are block diagrams illustrating several stages of operation to translate source code written using single instruction, single data (SISD) (and thus intended for execution in traditional CPU environments that are not SIMD capable) into executable code that leverages processor architectures capable of processing SIMD instructions.

FIG. 4 is a flowchart illustrating by way of example a procedure for generating a GPU kernel for an implementation of an SQL intrinsic function.

FIG. 5 illustrates a more detailed procedure for compiling an SQL intrinsic function to an executable native code.

FIGS. 6A, 6B, and 6C illustrate example transformations of source code to a native dialect IR as described above.

FIGS. 7A, 7B, 7C, and 7D illustrate a more complex optimization for an example SQL intrinsic function.

FIGS. 8A and 8B illustrate another optimization for improved parallel execution.

FIG. 9 is a block diagram of an example computing device (e.g., a computer storage device) for implementing aspects disclosed herein.

Corresponding reference characters indicate corresponding parts throughout the drawings. Any of the figures may be combined into a single example or embodiment.

### DETAILED DESCRIPTION

Traditionally, to take advantage of vectorization and data-parallelism using single instruction multiple data (SIMD) or single instruction multiple thread (SIMT) instructions, source code is written utilizing these instructions and libraries tailored for specific execution environments, including the presence in an execution environment of a particular graphics processing unit (GPU) or vector-capable central processing unit (CPU). Using modern compiling techniques, it is possible to generate a platform independent intermediate representation (IR) of the source code, which can then be optimized in various ways.

The Low Level Virtual Machine (LLVM) project has produced a specification for multi-level IR (MLIR), including a collection of modular and reusable compiler and toolchain technologies designed to provide flexible and extensible IR that can be used to represent and optimize code at multiple levels of abstraction. MLIR can be used to represent structured query language (SQL) query implementations in a structured intermediate form making it easier to optimize, and to perform optimizations on the IR of the intrinsic function implementations.

For example, certain patterns in the IR might be recognized and reconfigured in a manner that does not change the result of the execution, but that when lowered (e.g., loaded) to the processor backend, SIMD or SIMT instructions specific to the execution environment can be implemented that dramatically improves overall performance of the implementation.

The technology described herein improves the efficiency of computing devices, for example, reducing power consumption by dramatically reducing execution time of intrinsic SQL functions without rewriting source code implementations of these intrinsic functions.

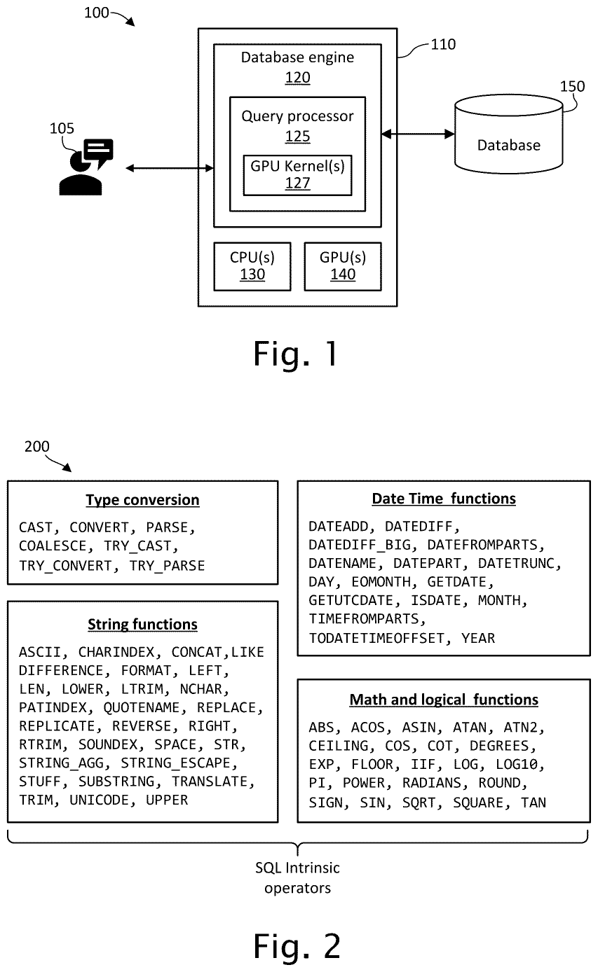

FIG. 1 is a block diagram illustrating by way of example an execution environment 100 for a database engine 120. Execution environment 100 includes a server 110 which comprises a computing platform including one or more central processing units (CPUs) 130 and GPUs 140 which support execution of database engine 120. Database engine 120 includes an application programming interface (API) (not separately shown) for receiving SQL queries from, and returning results to, user 105. Server 110 also has interfaces (not shown) for accessing database 150 which, in an example implementation, exists as one or more files in a data storage device or array, either locally on server 110 or remotely in a SAN or other centralized or cloud-based data storage system. Queries are processed using query processor 125, which is a component of database engine 120. Query processor 125 includes routines in machine-executable code for implementing a large variety of SQL intrinsic functions. In an example implementation, one or more intrinsic functions are implemented as GPU kernel 127 with data parallelism using SIMT instructions for execution on GPU 140. In another example implementation, one or more intrinsic functions are implemented for execution on CPU 130, which has native parallelism for executing vectorized (i.e., SIMD) instructions, as described in further detail below.

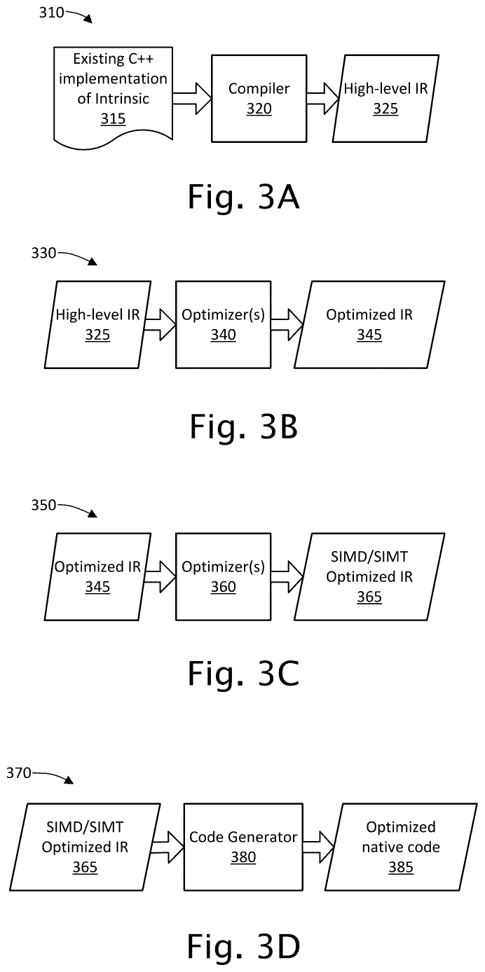

FIG. 2 shows a sampling of intrinsic operators 200 that can be used within an SQL query to process data. Each intrinsic operator corresponds with one or more intrinsic functions. The term, “intrinsic function” is used interchangeably with “built-in function” to refer to functions that are provided by the SQL database system itself, are pre-defined and ready to use without any need for user definition. In that sense, intrinsic functions come with the SQL database system and are part of the system's standard library and can therefore be used directly in SQL queries. Intrinsic functions include scalar functions such as “UPPER( )” and aggregate functions such as “SUM( ).” Certain intrinsic operators, such as “CAST( )”, require multiple different intrinsic functions since it is responsible for converting data between over 25 different data types. As illustrated in FIG. 2, intrinsic operators 200 fall into several different categories including type conversion, date-time functions, string functions and math/logical functions.

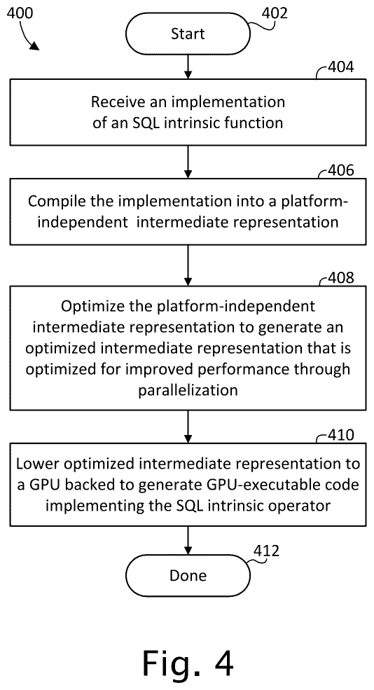

FIGS. 3A-3D are block diagrams illustrating several stages of operation to translate source code written using single instruction, single data (SISD) (and thus intended for execution in traditional CPU environments that are not SIMD or SIMT capable) into executable code that leverages processor architectures capable of processing SIMD or SIMT instructions.

FIG. 3A illustrates a first stage 310 for compiling existing C++ (or other high-level) source code 315 implementations of SQL intrinsic functions into high-level IR 325 of the SQL intrinsic functions using compiler 320. Source code 315 is written without the use of GPU or other accelerator-specific libraries, and without the use of SIMD or SIMT instructions. As such, source code 315 is suitable for compiling directly to a traditional CPU with a SISD instruction set.

Compiler 320 is the front end of a retargetable compiler suitable for generating IR code (e.g., in an MLIR format such as high-level IR 325). In an example implementation, compiler 320 is Polygeist, a project within the LLVM ecosystem. However, aspects of the disclosure are operable with other compilers. Compiler 320 is configured to produce high-level IR 325 which is platform independent, meaning that it contains no instructions that could restrict the final result to a particular execution environment.

FIG. 3B illustrates a second stage 330 for optimizing the high-level IR 325 into optimized IR 345 using one or more optimizers 340. Each “optimizer” corresponds to a compiler's optimization pass and serves to transform IR code to improve overall performance. Optimizers 340 perform transformations of high-level IR 325 into optimized IR 345 that remains platform independent but, due to the optimizations, will improve overall performance of the implementation when compiled using SIMD or SIMT instructions for parallel execution. Examples and details of such transformations are described below.

FIG. 3C illustrates a third stage 350 for transforming, using optimizer(s) 360, optimized IR 345 into a SIMD or SIMT optimized IR 365. Depending on the target execution environment, different LLVM dialects or optimizations may be applied by optimizers 360. Where the target execution environment includes vector-capable CPUs for executing SIMD instructions, vector-specific constructs and optimizations are employed to target vectorized instruction sets such as AVX, SSE, or NEON. Where the target execution environment includes one or more GPUs, SIMD/SIMT IR 365 is optimized using a GPU dialect of the LLVM platform that provides a structured way to express GPU programming concepts in MLIR format. The GPU programming concepts include threads and blocks, grid and block dimensions, shared memory, and synchronization. These constructs allow compilers to express GPU-specific computations in a structured and portable way.

FIG. 3D illustrates a fourth stage 370 for transforming, using code generator 380, SIMD/SIMT optimized IR 365 to optimized native code, which can include vectorized (i.e., SIMD) instructions for execution on a CPU or SIMT instructions implemented in a GPU kernel 140 (FIG. 1). A batch interface of GPU kernel 140 provides the capability to process a batch of rows of data for processing using SIMT instructions.

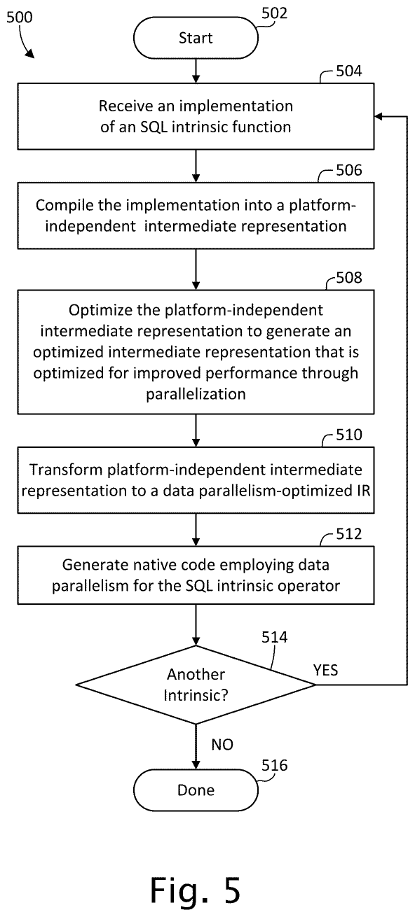

FIG. 4 is a flowchart illustrating by way of example a procedure 400 for generating native code employing data parallelism for an implementation of an SQL intrinsic function. In an example implementation, this procedure is performed by a compiler and/or a set of compilers and optimizers described above and illustrated in FIGS. 3A-3D. The procedure begins as indicated by start block 402 and flows to operation 404 wherein a source code implementation of an SQL intrinsic function is received by compiler 320. In an example implementation, the implementation is written in C++ or similar high-level language. In response to receiving the implementation, the procedure flows to operation 406 wherein compiler 320 compiles the source code implementation into an IR as previously described.

In operation 408, a series of optimization passes by one or more optimizers 340 are performed on the IR representation generated in operation 406 to form optimized IR 345. While the optimized IR 345 is platform independent, the optimizations are designed to improve performance when the IR is compiled into a native code using SIMD or SIMT instructions on vector-capable CPU 130 or GPU processor 140 (shown in FIG. 1). Additional optimizations are performed by one or more optimizers 360 to generate a SIMD or SIMT optimized IR.

In operation 410, a code generator 380 translates an optimized IR into an executable native code implements the intrinsic SQL function by employing data parallelism. For target execution environment lacking GPU support, the native code includes vectorized (i.e., SIMD) instructions. For a target execution environment including a GPU, the native code comprises a GPU kernel including SIMT instructions to implement the intrinsic SQL function. Procedure 400 then ends as indicated by block 412.

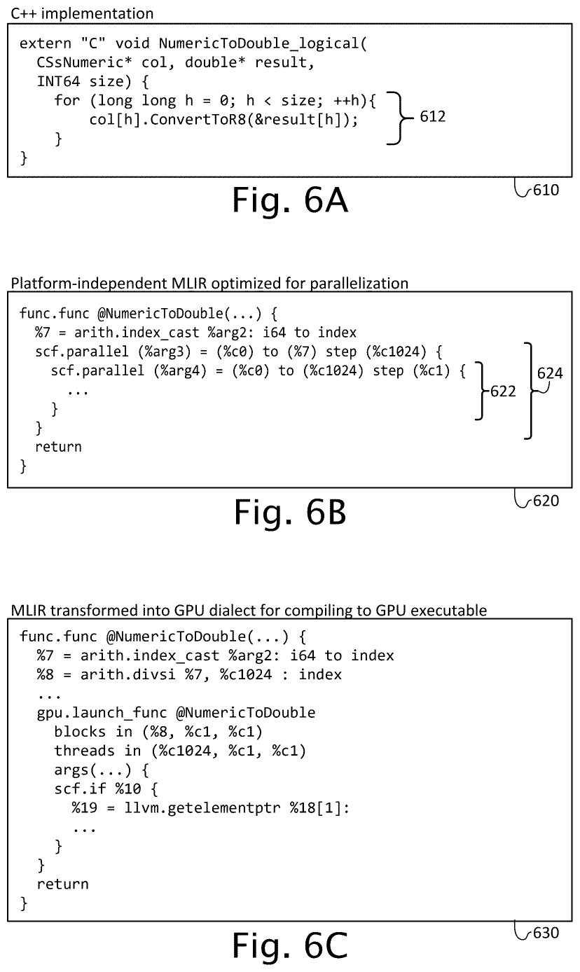

FIG. 5 illustrates a more detailed procedure 500 for compiling an SQL intrinsic function to executable native code. Procedure 500 begins as indicated at start block 502 and proceeds to operation 504 wherein a source code implementation 315 of the SQL intrinsic function is received. Responsive to receiving the source code implementation 315, procedure 500 flows to operation 506 wherein compiler 320 generates a platform independent high-level IR 325 as previously described with reference to FIGS. 3A, 4.

In operation 508, high-level IR 325 is optimized by one or more optimizers 340 to generate optimized IR 345 that is platform independent but optimized for improved performance through parallelization.

Operation 510 further optimizes the optimized IR 345 and transforms IR 345 into a data parallelism-optimized IR 365. In an example, data parallelism-optimized IR 365 includes GPU-specific constructs for parallel execution. In this instance, the data parallelism-optimized IR 365 is output by lowering through the GPU dialect of the LLVM framework. In another example, vector-specific constructs and optimizations are implemented within the data parallelism-optimized IR 365, such as by using existing features and extensions of the LLVM platform that are specialized for targeting vectorized instruction sets including AVX, SSE, and NEON. These include target-specific intrinsics which are directly mapped to SIMD instruction sets for CPUs, including loop vectorizers and superword level parallelism (SLP) vectorizers. These transformations lower a generic IR to an IR with explicit vector operations.

In operation 512, the data parallelism-optimized IR is lowered to executable native code 385 using code generator 380 (FIG. 3). Native code 385 employes data parallelism for improved performance. If the target execution environment is a CPU supporting vectorized (SIMD) instructions, native code 385 comprises SIMD instructions implementing the intrinsic SQL function. If the target execution environment includes a GPU capable of SIMT execution, native code 385 comprises a GPU kernel implementing the intrinsic SQL function.

In operation 514, it is determined whether additional SQL intrinsic functions require compiling to native code and if so, the flow returns to operation 504 to receive the next SQL intrinsic function. Otherwise, the procedure ends as indicated by block 516.

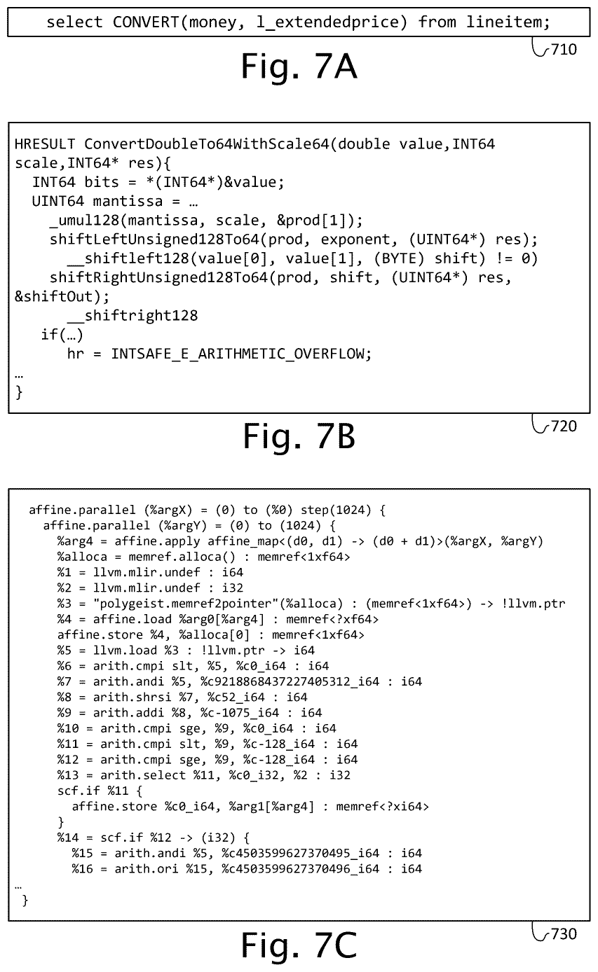

FIGS. 6A-6C illustrate an example transformations of source code to a data parallelism-optimized IR targeting a GPU as described above. FIG. 6A shows snippet 610 of a C++ implementation of an SQL intrinsic function for converting numeric data types. Snippet 610 includes loop 612 for iterating over an array of CSsNumeric objects, converting each element to a double-precision number and storing the result in the result array.

FIG. 6B illustrates a textual format of optimized MLIR code 620 generated from the source code implementation of the SQL intrinsic function shown in FIG. 6A. In this instance, the function is defined with func.func. and % 7 is an index cast to the size argument (% arg2). The loop 612 is transformed into nested parallel loop using scf.parallel, which allows for parallel execution. Outer loop 624 runs from 0 to % 7 in steps of 1024, and the inner loop 622 runs from 0 to 1024 in steps of 1.

FIG. 6C shows a transformation of optimized MLIR code 620 to GPU dialect IR 630. In this transformation, the size argument is cast to an index and again divided by 1024 to determine the number of blocks, stored in variable % 8. The gpu.launch_func is used to launch the function on the GPU and specifies the number of blocks and threads for the execution. The scf.if construct is used for conditional execution within the GPU kernel. llvm.getelementptr is used to get a pointer to an element in memory, enabling access to array elements.

The technique described above with reference to FIGS. 6A-6C is referred to as “reduction parallelism” or “loop tiling.” Loop tiling refers to the breaking of loops into smaller blocks to improve performance in different ways (e.g., by improving cache performance). Reduction parallelism is a technique to combine partial results from multiple parallel tasks into a single result, often with the “reduction” operator, which is typically associative and sometimes commutative, such as addition or subtraction. A reduction operator is an operator that reduces a set of values into a single value, such as the “SUM( )” intrinsic function in SQL. The task is divided into a set of smaller sub-tasks that can be executed simultaneously across multiple processors or threads. Each subtask (e.g., a sub-total in the SUM( ) function) computes a partial result. The partial results (e.g., sub-totals) are combined using the reduction operator to produce the final result (e.g., by adding the sub-totals together). This combination can be done in a hierarchical manner, often using a tree structure to efficiently merge results.

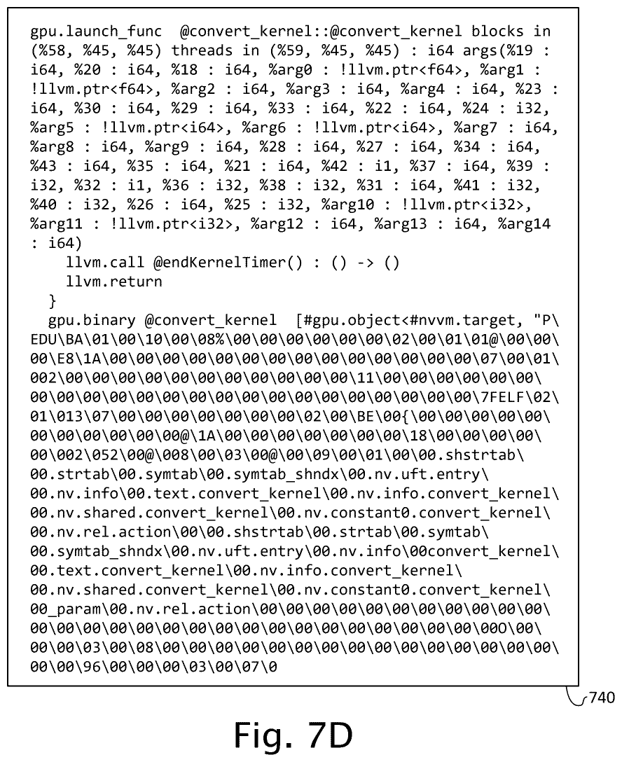

FIGS. 7A-7D illustrate a more complex optimization for the SQL intrinsic function “CONVERT( )”. FIG. 7A illustrates an example SQL query 710 for converting input data into a “money” data type. The SQL query applies the CONVERT intrinsic operator to transform the l_extendedprice field into the “money” datatype and retrieves the input data from the “lineitem” table. The money datatype is typically used to store currency values in SQL, and converting to the money data type requires careful, to-the-penny correctness.

FIG. 7B shows code snippet 720 of a source code implementation of the intrinsic SQL function “CONVERT( )”. As indicated in the code snippet, the conversion to MONEY type involves a number of arithmetic and bit-wise operations including representing the initial double-precision floating point number as a 64-bit integer, extracting the mantissa from the double's bit representation, multiplying the mantissa by a scale faction, shifting the bits to align the binary point appropriately, and performing an overflow check. In addition, certain corner cases need to be accounted for. For example, if the double's exponent is exactly 52, the rounding behavior can cause incorrect result due to the way floating-point arithmetic works, and these edge cases need to be handled, although such details are not shown in code snippet 720.

FIG. 7C shows a first transformation into a first IR 730 for the CONVERT( ) implementation described above. The transformation introduces parallel affine loops to distribute the workload. The intrinsic function's operations including mantissa extraction and bit-shifting are mapped directly into the MLIR instructions. The outer loop iterates over a range of 0 to % 0 in chunks of 1024. The declaration “affine.parallel” indicates that each iteration can run independently and in parallel. % argX represents the current iteration index of the outer loop. The inner loop, with index % argY, iterates over a fixed range from 0 to 1024 and is also declared as “affine.parallel” indicating it can run independently of other iterations. The nested loop structure facilitates concurrent processing of rows in the dataset (lineitem table) for the CONVERT operation.

FIG. 7D shows a second IR snippet 740 translates computations into GPU kernels. The gpu.launch_func maps the parallel affine loops from first IR 730 onto GPU thread blocks and grids. All arguments including pointers to memory buffers, loop bounds, etc., are passed to the GPU kernel. A binary representation of the GPU kernel is included at gpu.binary.

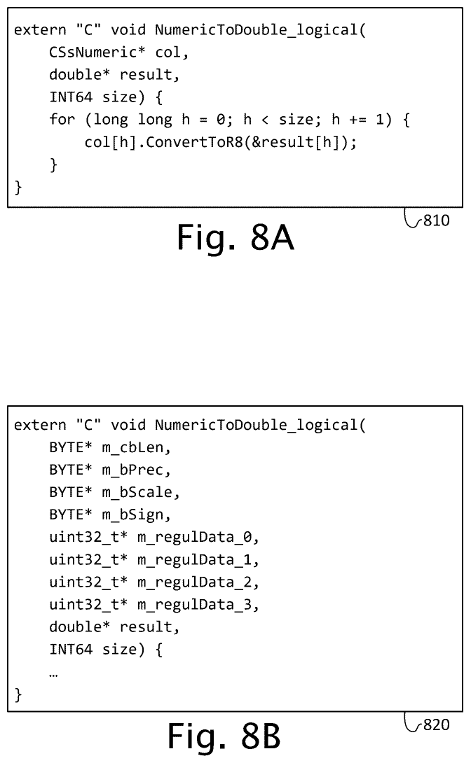

FIGS. 8A and 8B illustrate another optimization for improved parallel execution. Code snippet 810 includes the parameter “CSsNumeric*col” which represents an array of structures (AoS). Each element in this array (col[h]), is an instance of the CSsNumeric class/struct, which encapsulates multiple fields related to numeric data. FIG. 8B shows IR 820 in which the AoS organization of data presented in code snippet 810 is transformed into a structure of arrays (SoA). In IR 820, each field of the CSsNumeric structure is extracted into its own separate array which are passed as separate parameters to the function. This SoA layout is better suited for SIMD instructions and GPU-based parallelism because accessing the same field across multiple elements involves contiguous memory access. The SoA format provides a targeted CPU using SIMD instructions to operate on contiguous blocks of data in parallel, thereby facilitating efficient loading of multiple elements into SIMD registers. The SOA format also provides a targeted GPU using SIMT instructions for efficient access to contiguous data for coalesced memory accesses, thereby maximizing data throughput in the GPU. The SoA format provides efficient vector loads and stores, reduces shuffling, and facilitates straightforward loop vectorization by aligning data into SIMD-friendly memory patterns.

### EXAMPLE

An appendix attached hereto provides a computer program listing illustrating transformations for optimizing an input code as described herein and additionally illustrates a thread coarsening optimization. Starting at line 12 is a C++ implementation of a rounding function of the type often used to convert a number into a currency-like format. The function “I8RoundI8I4” takes a 64-bit integer and rounds or truncates it based on a specified decimal position. This function also manages special cases, such as very large or very small values (overflow) and the difference between truncating versus rounding (see line 61 in the C++ code). The function “RoundMoney_physical” then loops through a set of numbers, calling I8RoundI8I4 on each element.

At line 102, the first IR of the C++ source code, written in MLIR. It uses a simple loop “scf.for % arg4=0 to % arg2 step 1” loop (see line 123), which runs on the CPU and processes one element at a time. The rounding logic (lines 132-211) closely matches what the C++ function, but is expressed in MLIR syntax. There is no vectorization or GPU usage; the loop runs serially, relying on scaler (single-value) operations.

Lines 245 to 373 present a first optimized IR, which is optimized to leverage SIMD instructions on the CPU. Instead of processing one element per loop iteration, it now processes eight elements in each iteration, as shown in the loop (at line 273) which increments by 8 (“step % c8”). Within each iteration, the program loads eight 64-bit values at once (see, e.g., line 274, which uses “vector<8xi64>.” This vectorization allows the CPU to perform multiple operations simultaneously, significantly speeding up the overall rounding process.

Lines 375-557 show an additional optimization in which the IR is optimized for to GPU execution. Here, the CPU loop is replaced with GPU blocks and threads. Moreover, it uses a thread coarsening factor of 2, which means that each GPU thread handles two elements instead of just one.

Thread coarsening is a technique that reduces the total number of threads by having each thread do more work, and enables, through careful lowering, the use of wide load instructions on the GPU. This often leads to better utilization of the memory bandwidth on the GPU by fetching all the data needed to be processed by a thread in one instruction. In this IR, the compiler arranges for each GPU “block” to have 64 threads; since each thread handles two elements, each block processes 64×2=128 elements. This number can vary depending on the target GPU and performance considerations.

Overall, these transformations—from a straightforward CPU loop to a CPU vectorized version, then to a GPU offloaded version—optimize the same high-level C++ code for different hardware, improving speed or efficiency via parallelization, vectorization, and thread coarsening.

### Additional Examples

An example system for compiling an implementation of an intrinsic structured query language (SQL) function of an SQL query processor for execution leveraging data parallelism includes: a processor for executing instructions; and a data storage medium embodying instructions for execution on the processor, wherein the instructions cause the processor to: receive the implementation of the intrinsic SQL function, the implementation being an implementation of the intrinsic SQL function in source code using a high-level programming language, the implementation being targeted for execution on a central processing unit (CPU) and not including any calls to a GPU library or SIMD-specific instructions; compile the source code to generate an intermediate representation (IR) of the implementation of the intrinsic SQL function, the IR being platform independent; optimize the IR of the implementation of the intrinsic SQL function, the optimizing comprising modifying the IR to include data-parallelization, thereby resulting in an optimized IR; and lower the optimized IR to native code for execution on a processor with native parallelism.

Alternatively, or in addition to the other examples described herein, examples include any combination of the following:
Wherein the optimizing of the IR includes transforming loops to enable single instruction multiple thread (SIMT) instructions suitable for execution by a GPU.
Wherein the optimizing of the IR includes tiling loops and further optimizing the tiled loops for parallel execution.
Wherein the optimizing of the IR includes converting an array of structures (AoS) to a structure of arrays (SoA) to enable a GPU to distribute work across threads.
Wherein the instructions further cause the processor to transform the optimized IR of the implementation of the intrinsic SQL function to a GPU dialect, the GPU dialect including operations specific to GPU execution.
Wherein the native code comprises an executable GPU kernel for implementing the intrinsic SQL function.

An example method for processing structured query language (SQL) queries includes:
receiving an SQL query at an SQL query processor, the SQL query processor comprising a processor with native parallelism; identifying, within the SQL query, an intrinsic SQL function; processing the intrinsic SQL function on the processor using native code, the native code being generated from an implementation of the intrinsic SQL function in a platform-independent source code; the generating of the native code comprising: compiling the source code to generate an intermediate representation (IR) of the implementation of the intrinsic SQL function, the IR being platform independent and retargetable; optimizing the IR of the implementation of the intrinsic SQL function to generate an optimized IR, the optimizing comprising modifying the IR for improved performance through data parallelism; and lowering the optimized IR to the native code, the native code comprising SIMD or SIMT instructions for implementing the intrinsic SQL function.

Alternatively, or in addition to the other examples described herein, examples include any combination of the following:
Wherein the optimizing of the IR includes transforming loops to employ single instruction multiple data (SIMT) instructions suitable for execution by a graphics processing unit (GPU).
Wherein the optimizing of the IR includes tiling loops and further optimizing the tiled loops using a GPU dialect for parallel execution on a GPU.
Wherein the optimizing of the IR includes converting an array of structures (AoS) to a structure of arrays (SoA) to facilitate loop vectorization using SIMD instructions on the processor.
Wherein the generating of the native code further comprises transforming the optimized IR of the implementation of the intrinsic SQL function to a GPU dialect, the GPU dialect including operations specific to GPU execution.
Wherein the native code is one of a plurality of GPU kernels for processing a plurality of intrinsic SQL functions on the GPU.
Wherein the IR and the optimized IR are generated in MLIR format.

An example computer storage medium embodies computer program instructions for execution by a processor to process SQL queries, the instructions causing the processor to:
receive an SQL query; identify, within the SQL query, an intrinsic SQL function; process the intrinsic SQL function on a processor using native code, the native code being compiled from an implementation of the SQL intrinsic function in a platform-independent source code; the compiling of the native code comprising: compiling the source code to generate an intermediate representation (IR) of the implementation of the intrinsic function, the IR being platform independent and retargetable; optimizing the IR of the implementation of the intrinsic function to generate an optimized IR, the optimizing comprising modifying the IR for improved performance through data parallelism; and lowering the optimized IR to the native code, the native code comprising SIMD or SIMT instructions for implementing the intrinsic SQL function.
Wherein the optimizing of the IR includes transforming loops to employ single instruction multiple data (SIMD) instructions suitable for execution by a CPU having vectorization support.
Wherein the optimizing of the IR includes tiling loops and further optimizing the tiled loops for parallel execution on the processor.
Wherein the optimizing of the IR includes converting an array of structures (AoS) to a structure of arrays (SoA) to enable the processor to operate on contiguous blocks of data in parallel.
Wherein the optimizing of the IR further comprises transforming the optimized IR of the implementation of the intrinsic function to a data-parallelism optimized IR including vector-specific constructs targeting vectorized instruction sets.
Wherein the native code comprises one of a plurality of software modules that include SIMD instructions for processing SQL intrinsic functions on the processor.
Wherein the IR and the optimized IR are generated in MLIR format.

### Example Operating Environment

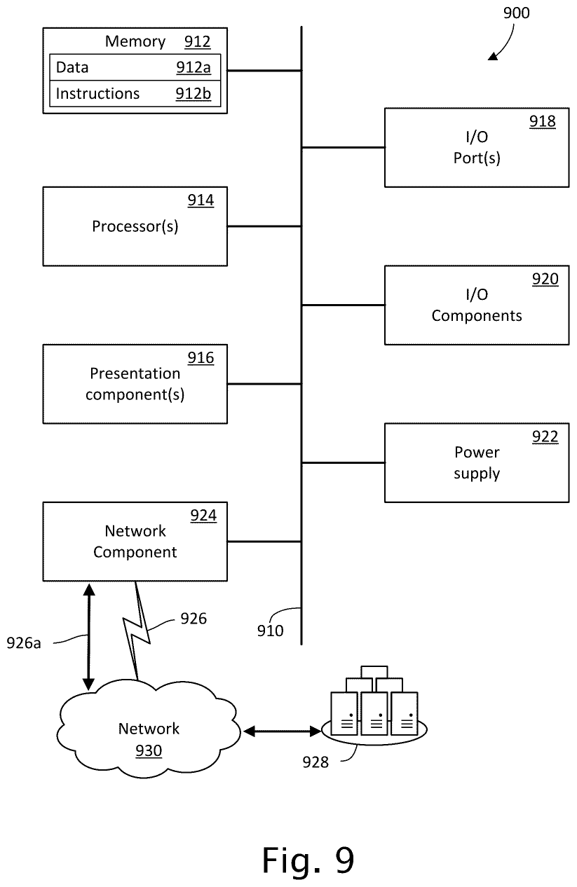

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein can be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples can be practiced in a variety of system configurations, including personal computers, laptops, smart phones, mobile tablets, hand-held devices, consumer electronics, specialty computing devices, etc. The disclosed examples can also be practiced in distributed computing environments when tasks are performed by remote-processing devices that are linked through a communications network.

Computing device 900 includes a bus 910 that directly or indirectly couples the following devices: computer storage memory 912, one or more processors 914, one or more presentation components 916, input/output (I/O) ports 918, I/O components 920, a power supply 922, and a network component 924. While computing device 900 is depicted as a seemingly single device, multiple computing devices 900 can work together and share the depicted device resources. For example, memory 912 is distributed across multiple devices, and processor(s) 914 is housed with different devices.

Bus 910 represents one or more buses (such as an address bus, data bus, or a combination thereof). Although the various blocks of FIG. 9 are shown with lines for the sake of clarity, delineating various components can be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 can take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein.

In some examples, memory 912 includes computer storage media. Memory 912 can include any quantity of memory associated with or accessible by the computing device 900. Memory 912 can be internal to the computing device 900 (as shown in FIG. 9), external to the computing device 900 (not shown), or both (not shown). Additionally, or alternatively, the memory 912 can be distributed across multiple computing devices 900, for example, in a virtualized environment in which instruction processing is carried out on multiple computing devices 900. For the purposes of this disclosure, “computer storage medium,” “computer-storage memory,” “memory,” and “memory devices” are synonymous terms for the computer-storage memory 912, and none of these terms include carrier waves or propagating signaling.

Processor(s) 914 includes any quantity of processing units that read data from various entities, such as memory 912 or I/O components 920. Specifically, processor(s) 914 are programmed to execute computer-executable instructions for implementing aspects of the disclosure. The instructions can be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represent an implementation of analog techniques to perform the operations described herein. For example, the operations are performed by an analog client computing device 900 and/or a digital client computing device 900. Presentation component(s) 916 present data indications to a user or other device. Exemplary presentation components include a display device, speaker, printing component, vibrating component, etc. It should be understood that computer data can be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which can be built in. Example I/O components 920 include, for example but without limitation, a microphone, joystick, game pad, satellite dish, scanner, printer, wireless device, etc.

Computing device 900 can operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices can use any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 924 communicates over wireless communication link 926 and/or a wired communication link 926a to a remote resource 928 (e.g., a cloud resource) across network 910. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices might accept input from the user in any way, including from input devices such as a keyboard or pointing device, via gesture input, proximity input (such as by hovering), and/or via voice input.

Examples are described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium for storing information for access by a computing device. In contrast, communication media typically embody computer readable instructions, data structures, program modules, or the like in a modulated data signal such as a carrier wave or other transport mechanism and include any information delivery media.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In examples involving a general-purpose computer, aspects of the disclosure transform the general-purpose computer into a special-purpose computing device when configured to execute the instructions described herein.

It will be understood that the benefits and advantages described above can relate to one embodiment or to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer storage medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

As used herein, the term “set” is non-empty, and can also be referred to as a “group.”

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there might be additional elements other than the listed elements. The term “exemplary” is intended to mean “an example of.” The phrase “one or more of the following: A, B, and C” means “at least one of A and/or at least one of B and/or at least one of C.”

While the aspects of the disclosure have been described in terms of various examples with their associated operations, a person skilled in the art would appreciate that a combination of operations from any number of different examples is also within scope of the aspects of the disclosure.

What is claimed is:

1. A system for compiling an implementation of an intrinsic structured query language (SQL) function of an SQL query processor for execution leveraging data parallelism, the system comprising:
a processor for executing instructions; and
a data storage medium embodying instructions for execution on the processor, wherein the instructions cause the processor to:
receive the implementation of the intrinsic SQL function, the implementation being an implementation of the intrinsic SQL function in source code using a programming language, the implementation being targeted for execution on a central processing unit (CPU) and not including (i) any calls to a graphics processing unit (GPU) library or (ii) single instruction multiple data (SIMD)-specific instructions;
compile the source code to generate an intermediate representation (IR) of the implementation of the intrinsic SQL function, the IR being platform independent;
optimize the IR of the implementation of the intrinsic SQL function, the optimizing comprising modifying the IR to include data-parallelization, thereby resulting in an optimized IR; and
lower the optimized IR to native code for execution on a processor with native parallelism.

2. The system of claim 1, wherein the optimizing of the IR includes transforming loops to enable single instruction multiple thread (SIMT) instructions suitable for execution by a GPU.

3. The system of claim 1, wherein the optimizing of the IR includes tiling loops and further optimizing the tiled loops for parallel execution.

4. The system of claim 1, wherein the optimizing of the IR includes converting an array of structures (AoS) to a structure of arrays (SoA) to enable a GPU to distribute work across threads.

5. The system of claim 1, wherein the instructions further cause the processor to transform the optimized IR of the implementation of the intrinsic SQL function to a GPU dialect, the GPU dialect including operations specific to GPU execution.

6. The system of claim 1, wherein the native code comprises an executable GPU kernel for implementing the intrinsic SQL function.

7. A computerized method for processing structured query language (SQL) queries, the method comprising:
receiving an SQL query at an SQL query processor, the SQL query processor comprising a processor with native parallelism;
identifying, within the SQL query, an intrinsic SQL function;
processing the intrinsic SQL function on the processor using native code, the native code being generated from an implementation of the intrinsic SQL function in a platform-independent source code; the generating of the native code comprising:
compiling the source code to generate an intermediate representation (IR) of the implementation of the intrinsic SQL function, the IR being platform independent and retargetable;
optimizing the IR of the implementation of the intrinsic SQL function to generate an optimized IR, the optimizing comprising modifying the IR for improved performance through data parallelism; and
lowering the optimized IR to the native code, the native code comprising single instruction multiple data (SIMD) or single instruction multiple thread (SIMT) instructions for implementing the intrinsic SQL function.

8. The method of claim 7, wherein the optimizing of the IR includes transforming loops to employ SIMT instructions suitable for execution by a graphics processing unit (GPU).

9. The method of claim 7, wherein the optimizing of the IR includes tiling loops and further optimizing the tiled loops using a GPU dialect for parallel execution on a GPU.

10. The method of claim 7, wherein the optimizing of the IR includes converting an array of structures (AoS) to a structure of arrays (SoA) to facilitate loop vectorization using SIMD instructions on the processor.

11. The method of claim 7, wherein the generating of the native code further comprises transforming the optimized IR of the implementation of the intrinsic SQL function to a GPU dialect, the GPU dialect including operations specific to GPU execution.

12. The method of claim 7, wherein the native code is one of a plurality of GPU kernels for processing a plurality of intrinsic SQL functions on the GPU.

13. The method of claim 7, wherein the IR and the optimized IR are generated in MLIR format.

14. A computer storage medium embodying computer program instructions for execution by a processor to process structured query language (SQL) queries, the instructions causing the processor to:
receive an SQL query;
identify, within the SQL query, an intrinsic SQL function;
process the intrinsic SQL function on a processor using native code, the native code being compiled from an implementation of the SQL intrinsic function in a platform-independent source code; the compiling of the native code comprising:
compiling the source code to generate an intermediate representation (IR) of the implementation of the intrinsic function, the IR being platform independent and retargetable;
optimizing the IR of the implementation of the intrinsic function to generate an optimized IR, the optimizing comprising modifying the IR for improved performance through data parallelism; and
lowering the optimized IR to the native code, the native code comprising single instruction multiple data (SIMD) or single instruction multiple thread (SIMT) instructions for implementing the intrinsic SQL function.

15. The computer storage medium of claim 14, wherein the optimizing of the IR includes transforming loops to employ SIMD instructions suitable for execution by a CPU having vectorization support.

16. The computer storage medium of claim 14, wherein the optimizing of the IR includes tiling loops and further optimizing the tiled loops for parallel execution on the processor.

17. The computer storage medium of claim 14, wherein the optimizing of the IR includes converting an array of structures (AoS) to a structure of arrays (SoA) to enable the processor to operate on contiguous blocks of data in parallel.

18. The computer storage medium of claim 14, wherein the optimizing of the IR further comprises transforming the optimized IR of the implementation of the intrinsic function to a data-parallelism optimized IR including vector-specific constructs targeting vectorized instruction sets.

19. The computer storage medium of claim 14, wherein the native code comprises one of a plurality of software modules that include SIMD instructions for processing SQL intrinsic functions on the processor.

20. The computer storage medium of claim 14, wherein the IR and the optimized IR are generated in MLIR format.
